(19) United States
(12) Patent Application Publication
(10) Pub. No.: US 2016/0361742 A1
(43) Pub. Date: Dec. 15, 2016

(54) SOIL TEXTURE IMPROVING AGENT OR IMPROVEMENT MICROORGANISM PROLIFERATION AGENT, SOIL GROUND SOLIDIFICATION METHOD, IMPROVEMENT MICROORGANISM PROLIFERATION METHOD AND DECONTAMINATION METHOD, AND DECONTAMINATION METHOD OF SOIL CONTAMINATED WITH RADIOACTIVE MATERIAL

(71) Applicant: Osaki Corporation, Tokyo (JP)

(72) Inventor: Akihiro SEINO, Tokyo (JP)

(21) Appl. No.: 14/929,002

(22) Filed: Oct. 30, 2015

(30) Foreign Application Priority Data
Jun. 11, 2015 (JP) 2015-118663

(51) Int. Cl. B09C 1/08; E02D 3/02; B09C 1/10; C09K 17/14

(52) U.S. Cl. CPC B09C 1/08; C09K 17/14; E02D 3/02; B09C 1/10

(57) ABSTRACT

The present invention provides a soil improvement material that mainly contains malic acid and chitin, can separate radioactive substances from soil particles by means of cultured bacteria (bacteria living in soil, such as actinomycetes; hereinafter called improvement microorganisms) in a soil contaminated with radioactive materials, has a decontamination effect increasing the decontamination efficiency, and has a soil ground improvement effect capable of giving a ground having water permeability and sufficient strength by compacting the ground due to a soil consolidation performance improvement effect. With the agent containing chitin, improvement microorganisms proliferate in a contaminated soil for 7 days to 1 month as a microorganism proliferation and curing period of the improvement microorganisms, and contaminants (cesium) are incorporated and are removed from soil particles. The present invention is a soil texture improving agent or an improvement microorganism proliferation agent as a decontamination means of a soil contaminated with radioactive substances.

### BACKGROUND OF THE INVENTION

Field of the Invention

The present invention improves the drainage performance of soft ground, increases the viscosity of soil, improves ground properties, reinforces a soil slope, and is used in the field of solidification and improvement of soil used in various applications such as road construction and residential land development in terms of the performances of solidifying soil ground on the basis of the proliferation of microorganisms in various earthworks. By the performances of solidifying soil ground on the basis of the proliferation of microorganisms, the present invention also solves harmful contamination problems including soil contamination by radioactive substances and secondary damage such as groundwater contamination, or solidifies the soil surface that can be scattered by wind or the like on the basis of the proliferation of microorganisms, and is used in the radioactive substance decontamination field for preventing the radioactive substance contamination by wind damage.

Background Art

### CITATION LIST

### Patent Literature

[Patent Document 1] Japanese Patent Application Laid-Open No. 2014-174161

Conventional agents of proliferating bacteria having concentration ability for decontamination of radioactive substance-contaminated soils in which the bacteria having concentration ability live include an agent of proliferating bacteria having concentration ability for decontamination, and the agent is characterized by including malic acid as a main component (Japanese Patent Application Laid-Open No. 2014-174161).

The agent of proliferating bacteria having concentration ability for decontamination of radioactive substances according to claim 1 in Patent Document 1 is used for a decontamination method of a soil contaminated with radioactive substances and includes malic acid as a main component, and the agent of proliferating bacteria having concentration ability for decontamination of radioactive substances is characterized by being a liquid or a powder containing 40 to 95% of malic acid as the main component and 60 to 5% of citric acid in terms of blending ratio.

### SUMMARY OF THE INVENTION

It is described that with the conventional agent that is used for proliferating bacteria having concentration ability for decontamination of radioactive substances and includes malic acid as a main component, bacteria having the ability of concentrating radioactive substances in a contaminated soil proliferate for, for example, 1 to 3 months as a proliferation and curing period of the bacteria having radioactive substance concentration ability, and radioactive substances including cesium are incorporated and can be easily removed from soil particles by washing with water or air, for example (see paragraph 0012 in the description).

Higher soil improvement by a forceful improvement method using a cement-based solidification agent containing heavy metals, a large amount of lime, or a large amount of common cement as a conventional soil improvement material causes problems including soil contamination and secondary damage such as groundwater contamination.

Other solidification agents including malic acid, citric acid, or glucose also have problems including variations in the effective period and insufficient effectiveness depending on the amount of chitin contained in a subject soil.

For decontamination, a contaminated soil has been simply washed or plants haven been planted in a contaminated ground. In the present situation, however, contaminated water after washing and fine or smaller grain fractions are required to be disposed, and the reduction in volume of contaminated soil is still a challenge.

The present invention has an object to provide a soil texture improving agent and a soil and ground solidification method by using the performances of solidifying soil ground on the basis of the proliferation of microorganisms. To decontaminate a radioactive substance-contaminated soil by the decontamination of radioactive substances in soil in terms of the performances of solidifying soil ground on the basis of the proliferation of microorganisms, microorganisms such as actinomycetes that absorb radioactive substances are proliferated in soil, and the soil texture improving agent present in soil allows actinomycetes and the like to proliferate and to effectively absorb and incorporate the radioactive substances, thereby removing the radioactive substances attached to soli particles. The present invention thus aims to decontaminate contaminated grounds by the proliferation and growth of microorganisms such as actinomycetes.

The present invention also has an object to provide a soil texture improving agent for decontamination of radioactive substances and for solidification of soil, a biodecontamination method, and a soil ground solidification method. According to the invention, by separating soli particles of the ground from improvement microorganisms such as actinomycetes containing radioactive substances, the microorganisms such as actinomycetes containing radioactive substances can be separated and removed from the soil without contamination of radioactive substances. This can eliminate the necessity of keeping a large space for disposal of the soil contaminated with radioactive substances unlike existing methods. The volume of the contaminated soil can be greatly reduced by collecting the microorganisms such as actinomycetes containing radioactive substances, and environmental problems can be greatly improved.

The present invention further aims to allow actinomycetes and the like as improvement microorganisms in a contaminated soil to proliferate for a proliferation and curing period (7 days to 1 month) of the microorganisms as the improvement microorganisms with the agent containing chitin, to allow the microorganisms such as actinomycetes to incorporate radioactive contaminants such as cesium, and to remove the contaminants from soil particles.

The soil particles without contamination are separated from the microorganisms containing radioactive substances, and the actinomycetes and the like as the improvement microorganisms are treated. Consequently, existing problems of accumulation of contaminated soil can be solved at once, and the volume of contaminated soil can be reduced. The present invention thus aims to effectively, reliably achieve decontamination.

A cement-based solidification agent containing heavy metals inevitably leads to the contamination of soil by the heavy metals. This also involves the effect on groundwater. In addition, water that flows on the surface of an improvement body by rainfall or the like unfortunately has a higher pH and flows into rivers to affect aquatic animals and plants.

When used, a large amount of lime or common cement generates a large amount of heat to make operations dangerous, cracks are generated, and thoroughly stirring becomes difficult due to the lack of stability, resulting in uneven decontamination. As for soil particles themselves, improvement specific to organic soil is not performed, and thus an improved soil has rough density, has many voids with no water permeability, and has uneven strength.

An improvement body mainly containing malic acid, citric acid, and glucose in combination causes problems including variations in the effective period and insufficient effectiveness depending on the amount of chitin contained in a subject soil.

The separation between soil particles and radioactive substances is difficult, and complete separation and taking-out are difficult by washing, giving poor efficiency.

Washing water contains radioactive substance, and thus is required to be treated.

By conventional plant treatment, improvement microorganisms as a medium that helps plants to absorb radioactive substances such as cesium are present in small amounts in soil, thus the radioactive substances are left in the soil, and the effect cannot be obtained.

A soil washing technique by using surface polishing of soil particles increases the amounts of contaminated fine grain fractions to increase the disposal amounts of treated contaminants, and such soil particles cannot be reused as a soil for cultivation due to the lack of fine grain fractions.

The present invention has an object to provide a soil texture improving agent that improves the drainage performance of soft ground, increases the viscosity of soil, improves ground properties, reinforces a soil slope, and is used in the field of solidification and improvement of soil used in various applications such as road construction and residential land development in the soil solidification by various soil works and to provide a soil and ground solidification method. The present invention aims to solve harmful contamination problems including soil contamination by radioactive substances and secondary soil damage such as groundwater contamination. The present invention aims to solidify the soil surface that can be scattered by wind or the like to prevent the radioactive substance contamination by wind damage. In the decontamination of radioactive substance-contaminated soil, microorganisms such as actinomycetes that absorb radioactive substances are allowed to proliferate in soil to effectively absorb and incorporate the radioactive substances, and consequently the radioactive substances attached to soil particles can be removed. The present invention aims to decontaminate contaminated grounds by the proliferation and growth of microorganisms such as actinomycetes.

By separating soil particles of the ground from improvement microorganisms such as actinomycetes containing radioactive substances, the microorganisms such as actinomycetes containing radioactive substances can be separated and removed from the soil without contamination of radioactive substances. This can eliminate the necessity of keeping a large space for the soil contaminated with radioactive substances unlike existing methods. The volume of the contaminated soil can be greatly reduced by collecting the microorganisms such as actinomycetes containing radioactive substances. The present invention thus aims to greatly improve environmental problems.

An invention according to claim 1 is a soil texture improving agent or an improvement microorganism proliferation agent as a decontamination means of a soil contaminated with a radioactive substance. The soil texture improving agent mainly includes malic acid and chitin, the agent allows microorganisms such as actinomycetes to prolifatate, and the microorganisms incorporate a radioactive substance in the contaminated soil.

An invention according to claim 2 is a soil ground solidification method including mixing and stirring or injecting and infiltrating a soil texture improving agent mainly containing malic acid and chitin as a substance capable of giving a ground that has water permeability, is harmless to humans or animals, and has sufficient strength, with or into a soil ground, and then pressurizing and solidifying the soil ground to form a consolidation structure.

An invention according to claim 3 is a soil ground solidification method including uniformly spraying a soil texture improving agent mainly containing malic acid and chitin as a substance capable of giving a ground that has water permeability, is harmless to humans or animals, and has sufficient strength, on a soil ground, and solidifying only a surface of the soil.

An invention according to claim 4 is an improvement microorganism proliferation method and a decontamination method including uniformly spraying a soil texture improving agent mainly containing malic acid and chitin on a contaminated soil ground containing a radioactive substance, allowing microorganisms that incorporate a radioactive substance, such as actinomycetes, to proliferate in the soil for 7 days to 1 month as a microorganism proliferation and curing period of improvement microorganisms such as actinomycetes, allowing the proliferated improvement microorganisms such as actinomycetes to incorporate the radioactive substance such as cesium in the soil to remove the radioactive substance from soil particles, separating the improvement microorganisms from the soil particles, and treating the separated improvement microorganisms.

An invention according to claim 5 is a decontamination method of a soil contaminated with a radioactive material, the method including spraying and infiltrating an agent mainly containing malic acid in a liquid form or a powder form and chitin in a powder form on and into a soil to allow improvement microorganisms such as actinomycetes in the soil to proliferate, allowing the improvement microorganisms proliferated in the soil to incorporate a radioactive contaminant such as cesium for decontamination of a soil contaminated with a radioactive material, and separating soil particles from the improvement microorganisms such as actinomycetes containing the radioactive contaminant.

The present invention is a decontamination microorganism proliferation agent having the structure as above, and the proliferation agent can be selected from a liquid form and a powder form depending on an intended purpose and is used for increasing the soil decontamination performance even for a subject containing a small amount of chitin.

According to a soil improving agent of the present invention, malic acid cuts the linkage between soil particles through an electric charge to increase a consolidation performance, approaches individual soil particles and organic substances, covers individuals, and increases the adhesive strength. Then, by pressurizing and compacting the soil particles or by compacting the soil particles for a long period of time on the basis of a natural consolidation performance, improvement microorganisms proliferates due to the effect of malic acid and chitin to make the ground have an appropriate water content. Thus, the soil texture improving agent mainly containing malic acid and chitin can give a high-density ground having water permeability and sufficient strength.

As a secondary action, after the addition, bacteria living in soil proliferate in the ground soil and maintain and stabilize an appropriate water content and a high density depending on a soil texture. The soil texture improving agent can easily improve soil in a natural manner and increase the density without extinction of soil.

Radioactive contaminants including cesium in a subject soil are absorbed in the proliferated improvement microorganisms in a similar manner to the action on potassium in soil and are removed and separated from soil particles in the soil. This completes the separation of the soil particles from the microorganisms containing radioactive contaminants in soil. After the separation of the soil particles from the improvement microorganisms, the improvement microorganisms are treated. Consequently, the volume of a decontaminated soil can be reduced, and the decontamination can be effectively, reliably achieved. The separated soil particles are reused, and only the radioactive contaminant can be disposed. Reliable and efficient soil decontamination can be easily performed.

As apparent from the above description, the soil texture improving agent pertaining to the present invention is harmless to humans or animals. By mixing, infiltrating, or spraying and mixing the agent with, into, or on a subject soil, malic acid cuts the linkage between soil particles through an electric charge, and covers individual soil particles to increase the viscosity. By the effect of linking and fixing soil particles through bacteria living in soil, such as actinomycetes, due to malic acid and chitin, the soil particles are forcedly compacted or are naturally compacted by using adhesive strength for a long period of time. Thus, the soil can be activated in a natural manner, can be solidified while maintaining water permeability, and can have a higher strength. Such advantageous effects can be reliably achieved.

As for decontamination effects of the present invention, the agent is sprayed on and infiltrated into or mixed with a contaminated soil ground. Improvement microorganisms proliferate in the contaminated soil for a microorganism proliferation and curing period (7 days to 1 month) of the improvement microorganisms, and radioactive contaminants such as cesium are incorporated and are removed from soil particles. The improvement microorganisms are separated from the soil particles, and then the improvement microorganisms containing the radioactive substances are treated. Consequently, the reduction in volume and reliable decontamination can be effectively performed. The separated soil particles can be reused, and only the radioactive contaminants can be disposed. Hence, reliable and efficient soil decontamination can be easily performed.

In addition, in the decontamination by using plants such as sunflowers and coles, when the plants are planted in a contaminated soil medium after similar spray and infiltration or spray and mixing, radioactive contaminants such as cesium can be reliably transferred to the plants, and thus the decontamination can be effectively, reliably performed.

Radioactive contaminants such as cesium can be effectively incorporated, and the decontamination is extremely reliably performed.

### BRIEF DESCRIPTION OF THE DRAWINGS

FIG. 1 is a sectional view of a cover soil improvement structure according to the present invention.

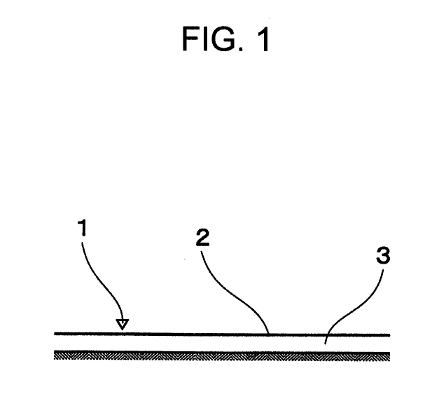

FIG. 2 shows a test of actinomycete proliferation effect in soil and is an image of the result of an improvement microorganism proliferation test where 12 cc (6 L/m²) of tap water was added to the soil, malic acid or chitin was not added as the test agents, and the test was performed for 168 hours.

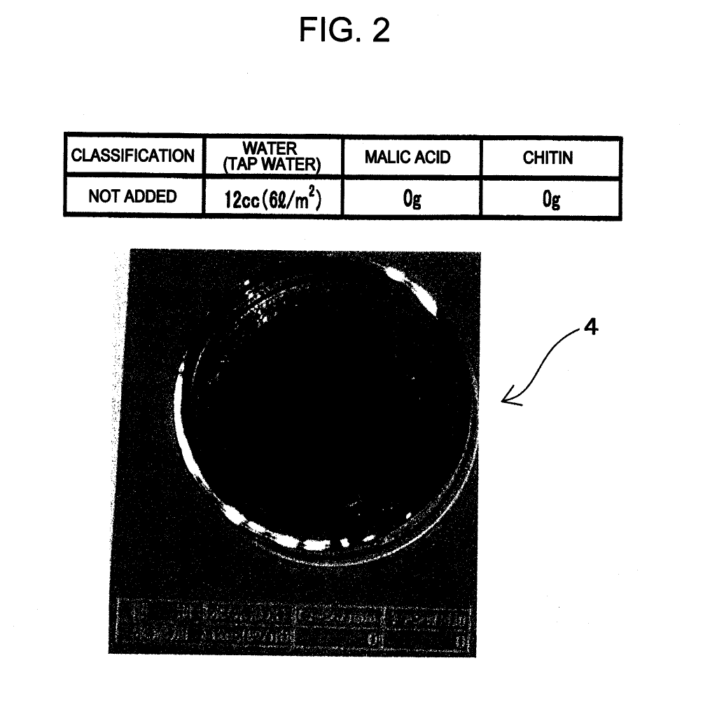

FIG. 3 shows a test of actinomycete proliferation effect in soil and is an image of the result of an improvement microorganism proliferation test where 12 cc (6 L/m²) of tap water was added to the soil, 0.2 g (100 g/m²) of malic acid was added, chitin was not added, and the test was performed for 168 hours.

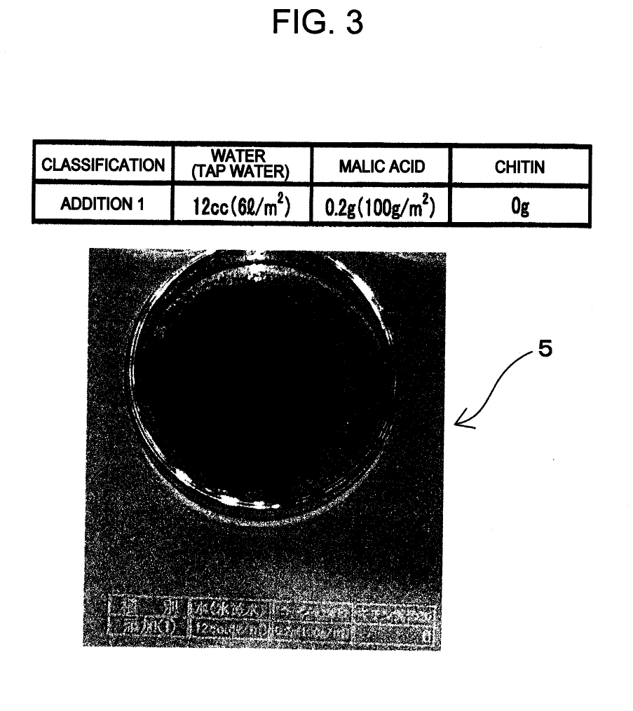

FIG. 4 shows a test of actinomycete proliferation effect in soil and is an image of the result of an improvement microorganism proliferation test where 12 cc (6 L/m²) of tap water was added to the soil, 0.2 g (100 g/m²) of malic acid was added, 0.04 g (20 g/m²) of chitin was added, and the test was performed for 168 hours.

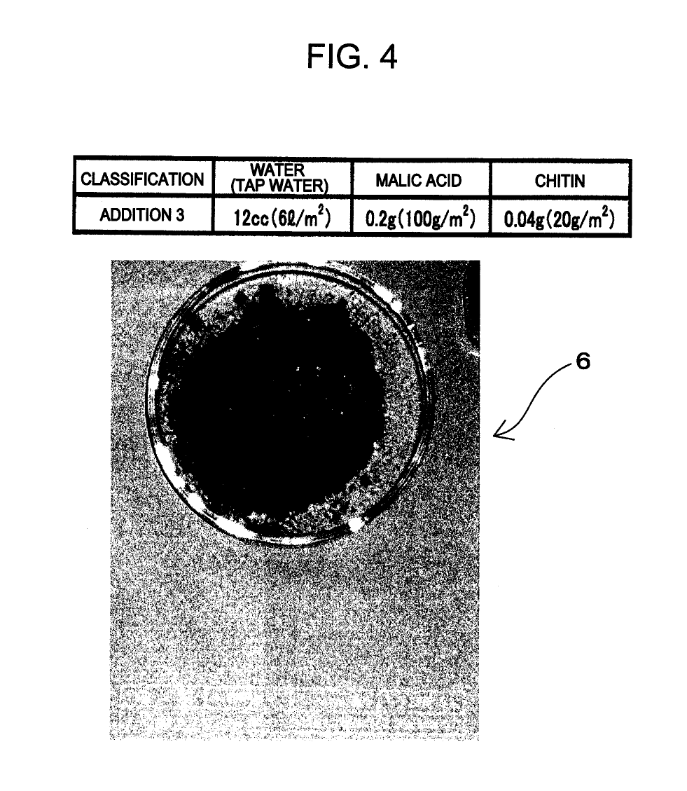

FIG. 5 shows a test of actinomycete proliferation effect in soil and is an image of the result of an improvement microorganism proliferation test where 12 cc (6 L/m²) of tap water was added to the soil, 0.4 g (200 g/m²) of malic acid was added, chitin was not added, and the test was performed for 168 hours.

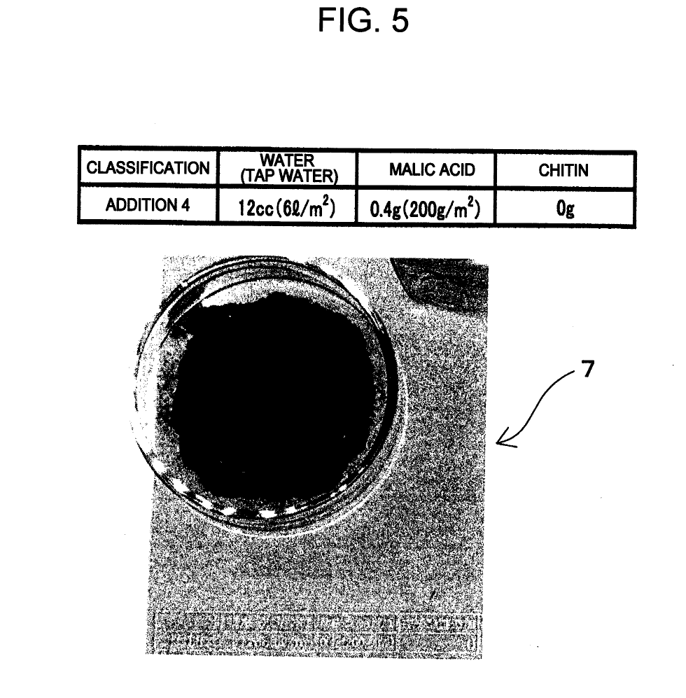

FIG. 6 shows a test of actinomycete proliferation effect in soil and is an image of the result of an improvement microorganism proliferation test where 12 cc (6 L/m²) of tap water was added to the soil, 0.4 g (200 g/m²) of malic acid was added, 0.04 g (20 g/m²) of chitin was added, and the test was performed for 168 hours.

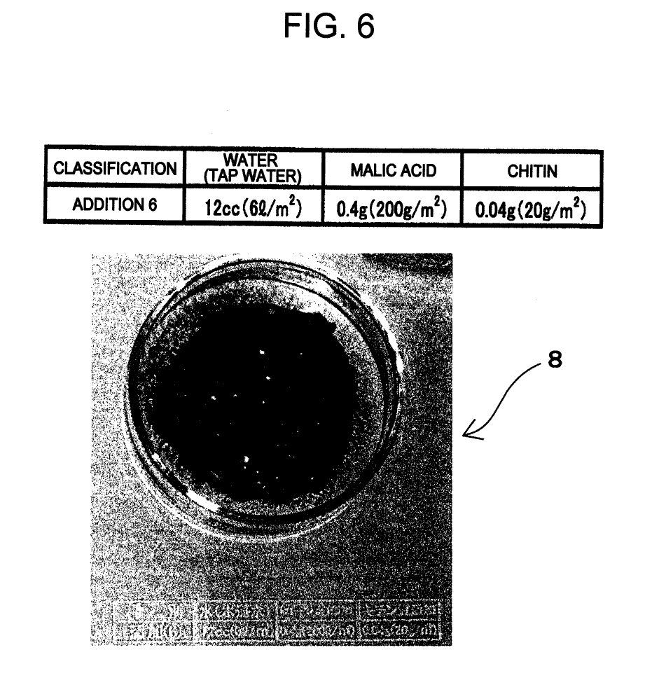

FIG. 7 shows a test of actinomycete proliferation effect in soil and is an image of the result of an improvement microorganism proliferation test where 12 cc (6 L/m²) of tap water was added to the soil, 0.4 g (200 g/m²) of malic acid was added, 0.1 g (50 g/m²) of chitin was added, and the test was performed for 168 hours.

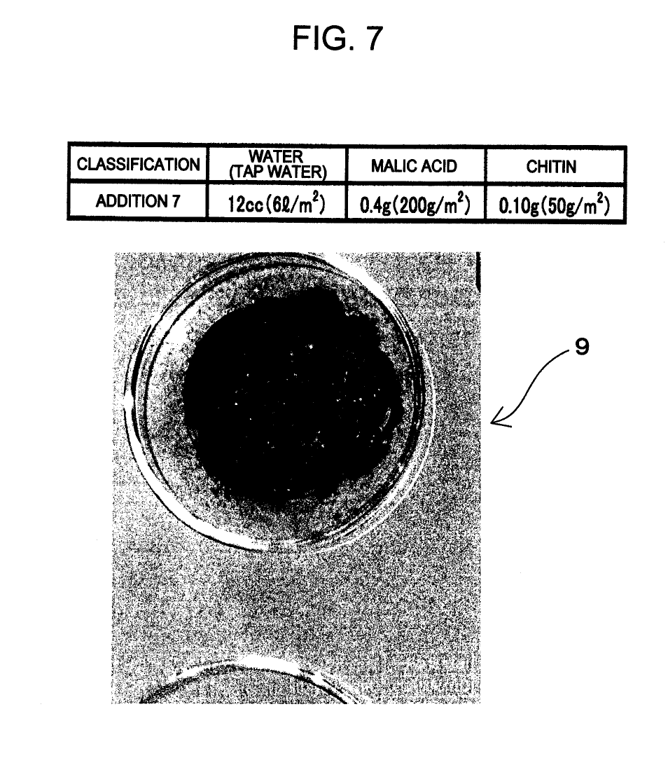

FIG. 8 shows a test of actinomycete proliferation effect in soil and is an image of the result of an improvement microorganism proliferation test where 12 cc (6 L/m²) of tap water was added to the soil, 0.6 g (300 g/m²) of malic acid was added, chitin was not added, and the test was performed for 168 hours.

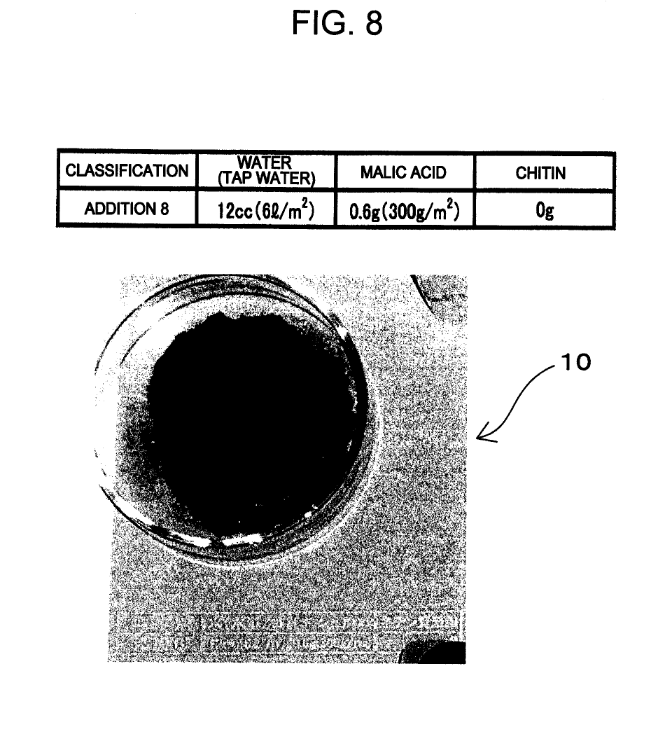

FIG. 9 shows a test of actinomycete proliferation effect in soil and is an image of the result of an improvement microorganism proliferation test where 12 cc (6 L/m²) of tap water was added to the soil, 0.6 g (300 g/m²) of malic acid was added, 0.04 g (20 g/m²) of chitin was added, and the test was performed for 168 hours.

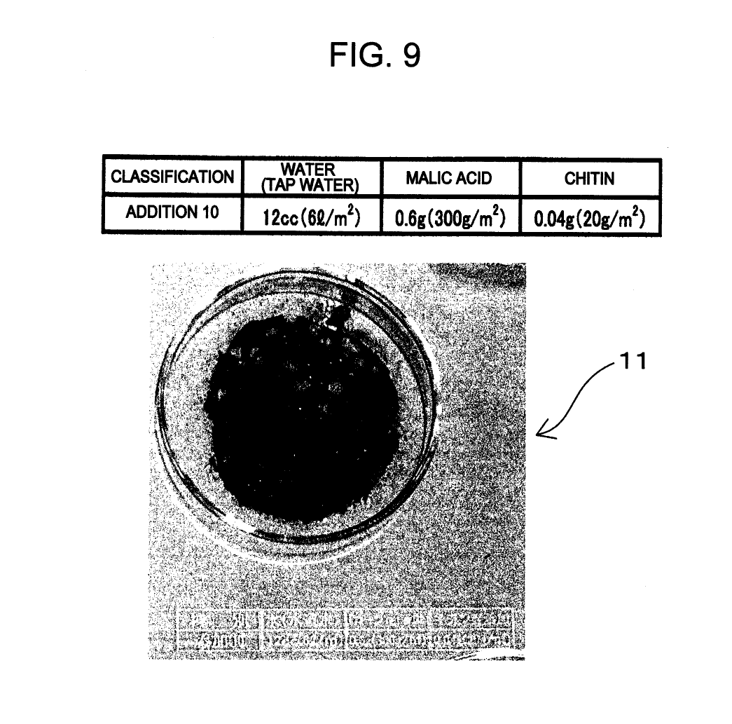

FIG. 10 shows a test of actinomycete proliferation effect in soil and is an image of the result of an improvement microorganism proliferation test where 12 cc (6 L/m²) of tap water was added to the soil, 0.6 g (300 g/m²) of malic acid was added, 0.1 g (50 g/m²) of chitin was added, and the test was performed for 168 hours.

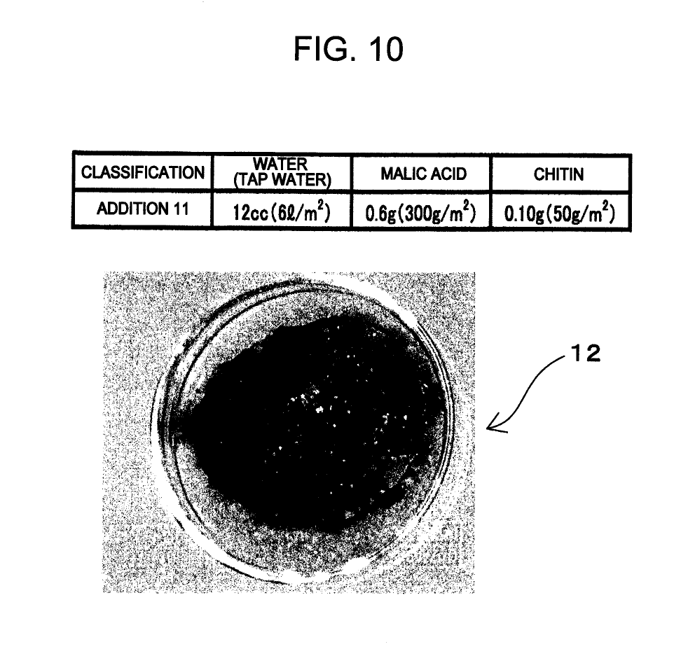

FIG. 11A is an explanatory diagram showing the state of soil before improvement; FIG. 11B is an explanatory diagram showing the soil containing the present agent immediately after rolling compaction; and FIG. 11C is an explanatory diagram showing the soil after the proliferation of improvement microorganisms.

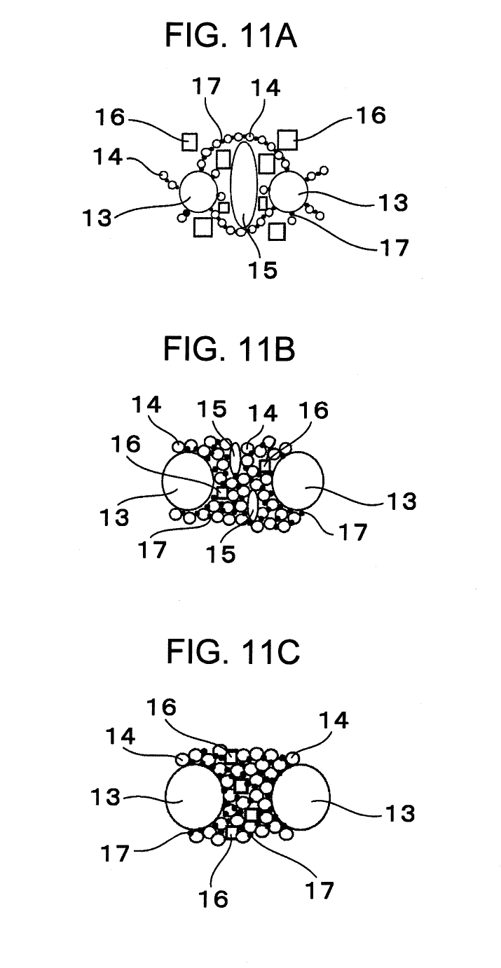

FIG. 12 is an explanatory diagram of a biodecontamination method.

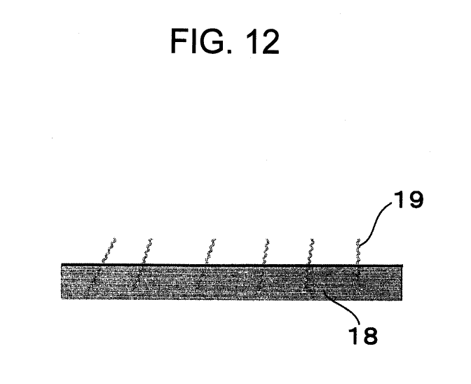

FIG. 13 is an explanatory diagram showing the relation between a soil particle and cesium.

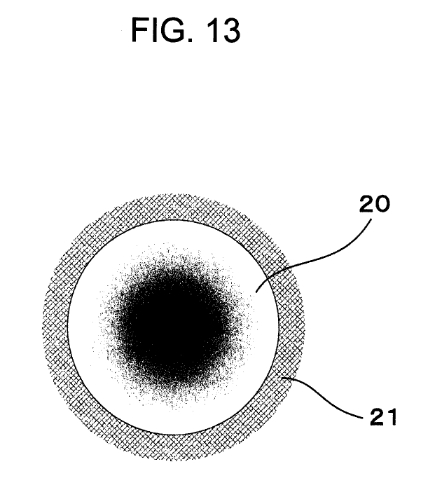

### DESCRIPTION OF THE PREFERRED EMBODIMENTS

### Example 1

(1) First, 1,600 kg/m³ of cohesive soil ground was compacted with a roller, and 10 g/m² of chitin was sprayed. Next, 150 g of malic acid was dissolved in water to give a concentration of 2 L/m², and the resulting solution was sprayed on and infiltrated into the soil ground, giving an improvement ground having a consolidation structure.

### Example 2

(2) With respect to 1,490 kg/m³ of humus soil, 633 g of malic acid and 10 g of chitin was added and infiltrated per cubic meter. Water among soil particles was removed by the effect of improving water content due to the proliferation of microorganisms, thus the water content was reduced, and the contraction density was increased, giving an improvement soil ground having a consolidation structure.

### Example 3

(3) With respect to 1,732 kg/m³ of highly organic soil ground containing pebbles, a total of 659 g including 649 g of malic acid and 10 g of chitin was mixed and stirred per cubic meter. The ground was then compacted with a roller. Water among soil particles was removed by the effect of improving water content due to the proliferation of microorganisms, thus the water content was reduced, and the contraction density was increased, giving an improvement ground having a consolidation structure.

### Example 4

(4) With respect to the surface of a ground that can be scattered when an embankment slope is reinforced or during road construction, residential land development, or the like, a mixed solution prepared by mixing 2 L of water and a total of 320 g including 300 g of malic acid and 20 g of chitin was sprayed and infiltrated, and only the surface was solidified. Consequently, prevention of scattering by wind and curing of earth and sand were able to be simply performed.

### Example 5

(5) An improvement microorganism proliferation agent that mainly contained malic acid in a liquid form and chitin in a powder form and enabled the decontamination of a soil contaminated with radioactive materials was obtained. The agent was sprayed on and infiltrated into or mixed with a contaminated soil ground. In the contaminated soil, improvement microorganisms proliferated for a microorganism proliferation and curing period (7 days to 1 month) of the improvement microorganisms, and a contaminant such as cesium was incorporated and was removed from soil particles. The improvement microorganisms were separated from the soil particles, then the improvement microorganisms were treated, and consequently the reduction in volume and reliable decontamination were able to be effectively performed. The separated soil particles were reused, and only the radioactive contaminants was able to be disposed. Reliable and efficient soil decontamination was able to be easily performed.

### Example 6

(6) An improvement microorganism proliferation agent that mainly contained malic acid in a liquid form and chitin in a powder form and enabled the decontamination of a soil was obtained. In the decontamination by using plants such as sunflowers and coles, when the plants were planted in a contaminated soil medium after similar spray and infiltration or spray and mixing, the improvement microorganisms were able to reliably transfer radioactive contaminants such as cesium to the plants. The method was able to suppress the problems in the field of the decontamination of a soil contaminated with radioactive materials by using plants and was able to achieve reliable decontamination with higher efficiency.

According to the present invention, radioactive contaminants generated from nuclear reactors, for example, damaged by a large earthquake are removed from soils contaminated with the radioactive substances in lands and fields near the nuclear power plant thereof. The lands and the like become free from the contaminants and are effectively used once again, and the lands where affected people can safely live can be provided. The invention greatly contributes the reconstruction of affected areas and the like.

### DESCRIPTION OF REFERENCE SIGNS

1 roller compaction

2 coating with malic acid at 150 g/2 L/m² and spraying of a chitin powder at 10 g/m²

3 the first improvement depth is 5 mm by spraying, and each rainfall advances the bioimprovement so as to give a final depth of about 5 cm.

4 test of actinomycete proliferation effect in soil (1)

5 test of actinomycete proliferation effect in soil (2)

6 test of actinomycete proliferation effect in soil (3)

7 test of actinomycete proliferation effect in soil (4)

8 test of actinomycete proliferation effect in soil (5)

9 test of actinomycete proliferation effect in soil (6)

10 test of actinomycete proliferation effect in soil (7)

11 test of actinomycete proliferation effect in soil (8)

12 test of actinomycete proliferation effect in soil (9)

13 rough soil particle

14 fine soil particle

15 air

16 water

17 clay or the like

18 contaminated soil ground

19 improvement microorganisms (removed from soil particles)

20 soil particle (cesium is attached to the surface)

21 decontamination microorganisms adsorbing cesium

1. A soil texture improving agent or an improvement microorganism proliferation agent as a decontamination means of a soil contaminated with a radioactive substance, the soil texture improving agent mainly comprising malic acid and chitin, the agent allowing microorganisms such as actinomycetes to proliferate, the microorganisms incorporating a radioactive substance in the contaminated soil.

2. A soil ground solidification method comprising:
mixing and stirring or injecting or infiltrating a soil texture improving agent mainly containing malic acid and chitin as a substance capable of giving a ground that has water permeability, is harmless to humans or animals, and has sufficient strength, with or into a soil ground; and then
pressurizing and solidifying the soil ground to form a consolidation structure.

3. A soil ground solidification method comprising:
uniformly spraying a soil texture improving agent mainly containing malic acid and chitin as a substance capable of giving a ground that has water permeability, is harmless to humans or animals, and has sufficient strength, on a soil ground; and
solidifying only a surface of the soil.

4. An improvement microorganism proliferation method and a decontamination method comprising:
uniformly spraying a soil texture improving agent mainly containing malic acid and chitin on a contaminated soil ground containing a radioactive substance;
allowing microorganisms that incorporate a radioactive substance, such as actinomycetes, to proliferate in the soil for 7 days to 1 month as a microorganism proliferation and curing period of improvement microorganisms such as actinomycetes;
allowing the proliferated improvement microorganisms such as actinomycertes to incorporate the radioactive substance such as cesium to remove the radioactive substance from soil particles;
separating the improvement microorganisms from the soil particles; and
treating the separated improvement microorganisms.

5. A decontamination method of a soil contaminated with a radioactive material, the method comprising:
spraying and infiltrating an agent mainly contacting malic acid in a liquid form or a powder form and chitin in a powder form on and into a soil to allow improvement microorganisms such as actinomycetes in the soil to proliferate;
allowing the improvement microorganisms proliferated in the soil to incorporate a radioactive contaminant such as cesium for decontamination of a soil contaminated with a radioactive material; and
separating soil particles from the improvement microorganisms such as actinomycetes containing the radioactive contaminant.
